(19) United States
(12) Patent Application Publication
(10) Pub. No.: US 2021/0353090 A1
(43) Pub. Date: Nov. 18, 2021

(54) SYSTEM AND METHOD FOR A PROCESS TO PROVIDE IMPROVED PREPARATION OF CONSUMABLES

(71) Applicant: John McDevitt, Clearwater, FL (US)

(72) Inventor: John McDevitt, Clearwater, FL (US)

(21) Appl. No.: 17/243,537

(22) Filed: Apr. 28, 2021

Related U.S. Application Data
(60) Provisional application No. 63/026,022, filed on May 16, 2020.

(51) Int. Cl. A47J 27/10; G05B 15/02; A47J 36/32; A47J 36/20; A47J 36/16; B01F 13/08; B01F 15/06; B01F 15/00

(52) U.S. Cl. CPC A47J 27/10; G05B 15/02; A47J 36/32; A47J 36/20; A47J 36/165; B01F 13/0818; B01F 2215/0014; B01F 15/00175; B01F 15/00389; A47J 2202/00; B01F 2015/062; B01F 2015/061; B01F 15/065

(57) ABSTRACT

A system and method for a process to prepare consumable food and/or drink products by means of precise heating and stirring for a set period of time. The system utilizes a variable rotation rate magnetic stirring process, a variable temperature heating process, and a timing process in order to prepare consumables. The magnetic stirrer provides agitation to a fluid medium and facilitates homogenous distribution of heat produced by the heating element throughout the fluid. This even distribution of heat creates an improved consumable preparation. The system is suitable for home use.

### CROSS REFERENCE TO RELATED APPLICATION

This application claims priority to U.S. Provisional Application No. 63/026,022, entitled System and Method for a Process to Provide Improved Preparation of Consumables, filed on May 16, 2020 the contents of which are incorporated herein by reference into the present application.

### BACKGROUND OF THE INVENTION

There are a variety of existing devices available that facilitate the cooking of food products in a circulating water bath usually referred to as; “Sous-vide”. Sous-vide specifically means “under vacuum”, but under common usage means cooking food sealed in an air-tight plastic bag submerged in a water bath. These devices have been used in professional settings for several years and are broadly seen as a very high quality cooking method, especially due to their ability to cook food evenly at precise temperature for precise amounts of time, resulting in nearly perfectly cooked food. Additionally, Sous-vide has also been used to reference food that has been previously cooked and is sealed in a vacuum bag, and then when it is to be served the cooked vacuum bagged food is warmed up in a water (or steam) bath prior to serving. However, many of these devices are not suitable for home use, and those that are, are usually single use devices that cannot be used for anything but to cook things sealed in a plastic bag in a water bath. Furthermore, these home Sous-vide devices generally just circulate water around a single horizontal plane within the cooking vessel. This planar rotational circulation of the water within the cooking vessel results in a higher degree of thermal heterogeneity of the fluid within the cooking vessel. This lack of homogeneity results in uneven cooking and a directly related lower quality cooked food product.

Moreover, since existing home Sous-vide devices are effectively (and designed to be) single use devices—they have no other role in a household kitchen. As a result of this single use nature, the limitations on a consumer's kitchen space to store cooking devices, and limitations on a consumer's available funds to purchase kitchen devices, a resulting limited number of consumers may be able to, or are inclined to purchase a traditional home Sous-vide device. Thus, while Sous-vide is often seen to be a superior cooking method these limitations and the poorer performance on cooking fluid homogeneity, cause fewer home Sous-vide devices to be purchased and used than would be otherwise.

### SUMMARY OF THE INVENTION

Accordingly, an improved system and method of preparing consumables is needed to allow individuals to enjoy the benefits of this cooking method. There is a need in the industry for a method and system that provides improved thermal homogeneity in the cooking bath fluid (and by extension the thermal homogeneity of the item being cooked), while also supporting cooking use beyond the traditional Sous-vide style. Thus, allowing the consumer to enjoy improved Sous-vide cooking and other cooking experiences without the undue burden of a single use device. The present invention prevents the waste of a user's resources and improves the user's overall preparation of consumables experience.

The system and method disclosed herein provides for a device for the improved preparation of consumables. This device, referred to as the Stir Perfect Cooking System (SPCS) will be described in more detail below but generally minimally consists of a base that contains a variable heating element (and related control), a variable rotating magnetic source (and related control), a temperature monitoring system, a timing system, a vessel that can contain fluid that can be heated, a magnetic stir bar (that can be placed in the vessel and magnetically couple to the rotating magnetic source), and a rack that may be contained within the vessel and serve to suspend cooking items above the magnetic stir bar. Please note that while the disclosed system may be used for a variety of applications in commercial food preparation, education, industries, or laboratories (all food related or non-food related), the exemplary case described in detail herein is for home food preparation use.

The terms “preparation” and “cooking” are used generically and interchangeably throughout and may mean the heating, the stirring, or a combination of both of any substance contained in the vessel including consumable food product (solid, liquid, or a combination of both), or non-food product. The word “stir” in all its forms is used generically meaning mixing, or blending, or agitating, by means of moving an implement through a medium (for example, but not limitation—rotating a magnetic stir bar in a vessel of water). The cooking medium (fluid) is most often water but could be any other applicable fluid that may be used to cook in (e.g., oils, etc.). The fluid may be an individual fluid, a mixture of fluids, a suspension, a slurry, or a combination of these. Furthermore, the fluid may act just as thermal environment for the substance being cooked, or it may be part of the substance that is being cooked. Also, the term “rule(s)” is used generically (often in the simplest form being If-Then statements) and may include one, some, or all set(s) of rules including, amongst others, temperature (or heating) rules (maximum, minimum, average, increase rate, decrease rate, heating testing/monitoring, etc.), stirring rules (maximum, minimum, average, increase rate, decrease rate, maximum torque, minimum torque, stirring testing/monitoring, stir rate randomization, etc.), and timing rules (start, stop, duration, etc.). The rules may be set by an individual, group, a system, a computer, or a combination of any of these. The rules may be pre-established or dynamically established, or a combination of both. Furthermore, “user”, “consumer”, “individual”, “preparer”, “cook”, and “chef” are used interchangeably, generically, and could mean any one that uses the SPCS and the user could be a human individual, a group of humans, an animal or animals, another computer system, or set of systems.

In different embodiments, the SPCS may have internal to the device or connected to the device a computational system as described in FIG. 7. Also, the SPCS may send and receive data and be controlled locally to the device or remotely from it. The SPCS may be connected by means of a connection; wireless (e.g., 3G, 4G, 5G, etc.), wired, IP, Wi-Fi, Bluetooth, or similar two way communication technologies to any connected device (e.g., a smartphone, tablet, personal computer, computer system, laptop, media streamer, smart TV, smart home speaker, game console, AR/VR/MR viewers, smart home appliance, or the like) that can also support SPCS device communication. The SPCS reporting status data and related control data may be distributed and or received as a discrete set(s), may be streamed continuously, or may be a combination of two that are distributed in batches. Additionally, the disclosed system and method allows for the status and control data to be communicated in real time, near real time, or stored and forwarded such that consumption or use data can be acted upon and or stored. This collected use data may provide data as the basis for a feedback loop that enables the system to dynamically learn and adjust the current and/or next cooking session.

In some embodiments, the disclosed system provides for continuously or periodically changing and updating the cooking rules such that over time the cooking rules are different than those that were initially created. These changes may be based on one or more of any relevant data including but not limited to; target cooking completion time change, desired food ending temperature changes, vessel temperature changes, environment temperature changes, mixing rate changes, cooking medium viscosity changes, etc. The feedback loop may use various sets of information and machine learning/artificial intelligence (ML/AI) analysis to improve the user experience and creating improved cooking. The disclosed system may use ML/AI systems using traditional or quantum computing methodologies to aid in arriving at improved cooking settings. Furthermore, these ML/AI based approaches may be used over time and can be applied to any type of cooking with the SPCS. This improvement process may be utilized for future cooking or also even after the cooking has already started and has not yet been completed may be altered based on this dynamic learning methodology (and/or feedback loop) to improve the remaining cooking time.

In alternative embodiments, the cooking may apply to non-human food items. The described system and method may also apply to educational, industrial, laboratory, scientific, or other similar environments where the SPCS may be applied in order to create an improved outcome. In these non-home and or non-human food applications aspects such as, but not limited to; the scale, the precision, the and/or accuracy of parameters related to settings such as temperature, stirring, timing, etc. may be outside those of traditional home use. Furthermore, the reporting and control systems may also differ from standard home application. Additionally, the described system and method may also apply is a low temperature environment where things are cooled producing or preparing chilled or “slushy” items.

### BRIEF DESCRIPTION OF THE DRAWINGS

FIG. 1 illustrates a block diagram of the SPCS (partial cross sectional front view) in accordance with an exemplary embodiment.

FIG. 2 illustrates a block diagram of the SPCS (top view) in accordance with an exemplary embodiment.

FIG. 3 illustrates a block diagram of the SPCS (top view—with cut away of top surface) in accordance with an exemplary embodiment.

FIG. 4 illustrates a block diagram of the SPCS control panel in accordance with an exemplary embodiment.

FIG. 5 illustrates a block diagram of the SPCS Stir Bar in accordance with an exemplary embodiment.

FIG. 6 illustrates a flowchart for a method of preparing consumables by means of utilizing SPCS in accordance with an exemplary embodiment.

FIG. 7 illustrates an example of a general-purpose computer system in accordance with an exemplary embodiment.

### DETAILED DESCRIPTION OF THE INVENTION

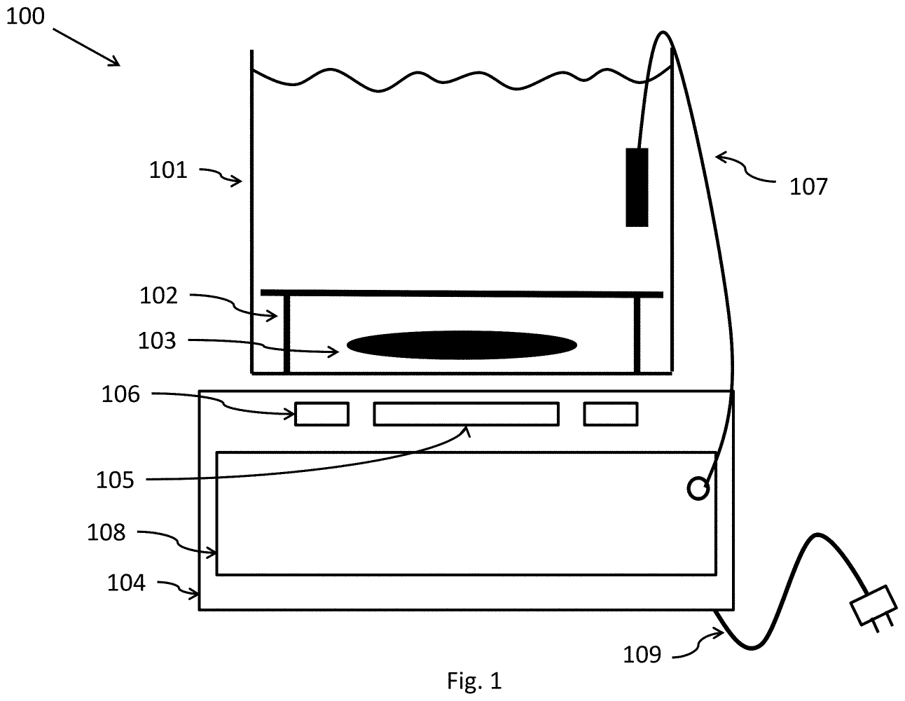

The following detailed description outlines possible embodiments of the proposed system and method disclosed herein for exemplary purposes. The system and method disclosed are in no way meant to be limited to any specific combination of hardware and software. A person skilled in the relevant art will recognize that other configurations and components may be utilized without departing from the scope of the disclosure. As will be described below, the system and method disclosed herein relate to the SPCS. An exemplary embodiment of the SPCS is captured is illustrated in FIG. 1 (100), which includes the components described below. It should be appreciated that each of the components are illustrated as simple block diagrams, but include the requisite hardware and software components needed to perform the specified functions as would be appreciated by one skilled in the art. For example, one or more of the components described below can include one or more general purpose computer systems configured to execute software programs stored on electronic memory in order to execute the algorithms disclosed herein, and these general purpose computer systems may be located together or apart.

For example, but not limitation, FIG. 1 (100) is a basic explanatory representation in the form of block diagram partial cross sectional front view of the SPCS. In this exemplary embodiment a vessel (101) that serves as a container of fluid in which the cooking occurs (in this embodiment a cooking vessel). This vessel should be made of a substance that can be structured such that it maintains sufficient structural integrity to hold a fluid, is stable across a range of temperatures, and does not materially retard the rotation and effectiveness of the magnetic stir bar (103). In the given example, the vessel (101) may be made of a substance (or mix of substances) including but not limited to; glass (e.g., Pyrex®), plastic (e.g., Nalgene®), stainless steel, aluminum, copper, ceramic, etc. The vessel (101) may be a wide variety of sizes and shapes as long as the stirring and heating are effective. In the exemplary embodiment, the fluid in the vessel (101) is water, but in alternative embodiments other fluids (e.g., those with different viscosities or thermal capacities) may be used for specific applications. A rack (102) may also be placed into the vessel (101). The rack (102) is structured in such a way that it allows items that are to be cooked to be placed in the vessel (101) in such a way that the fluid that is being stirred may still move freely around the item to be cooked, maintaining thermal homogeneity while also not materially retarding the movement of the stir bar (103). The rack (102) may just be flat, or it may also have vertical sections that may act as dividers or supports for a bag or bags of food to be cooked. The rack (102) may be structured to work specifically with a given vessel (101) or it may be a generic rack (102) and be used with a wide variety of different vessels (101). It should also be noted that depending on the substance being cooked a rack may not be needed. Also, in alternative embodiments, the items being cooked (e.g., food in bags) may be placed in such a way that they are connected or attached (e.g., clipped, hooked, etc.) to the top edge, side, lid, etc. of the vessel (101) in such a way that they do not materially retard the rotation of the stir bar (103), nor reduce the thermal homogeneity of the cooking fluid. Additionally, the bag may have a rack (102) incorporated into its structure. Furthermore, the vessel (101) may have a lid or may not have a lid and if there is a lid, the lid may seal. In the embodiment where the vessel (101) has a lid that seals, the lid may be attached to the vessel (101) in such a way that it creates a hermetical seal and a pressure cooker environment is established, allowing in certain embodiments for the cooking to occur at higher pressures and potentially shorter times.

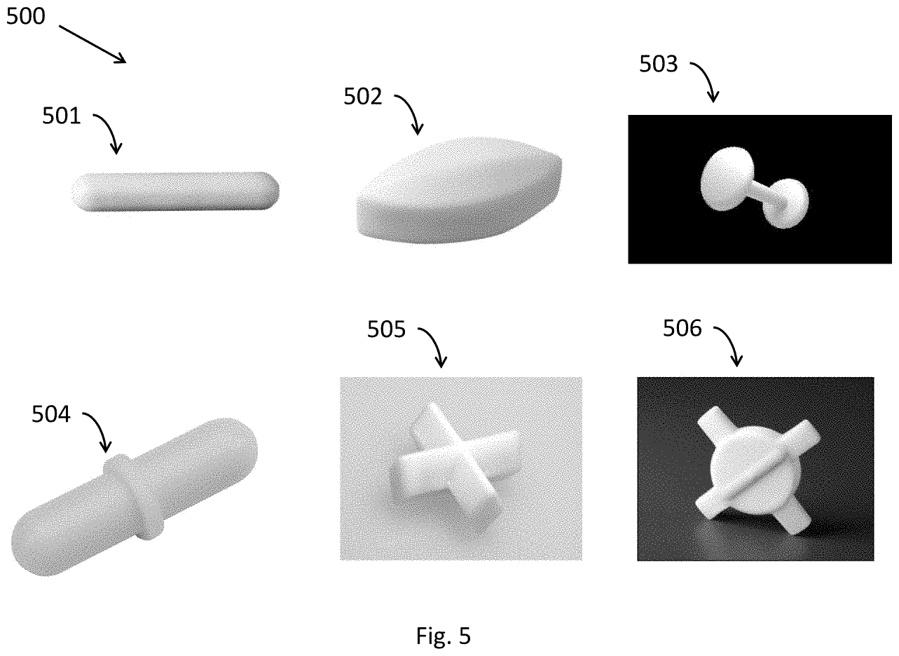

Furthermore, in the example of FIG. 1 (100) the stir bar (103) in the exemplary embodiment is a simple two pole permanent magnet that is bar shaped. The stir bar (103) is a magnet that may be made of neodymium iron boron (NdFeB), samarium cobalt (SmCo), alnico, ceramic/ferrite magnets, other magnetic substances, or a combination of these. The specific type of magnet used may depend on the application taking into consideration performance and cost. Generally neodymium iron boron (NdFeB) magnets are the strongest, but most expensive and may be best in applications where strong stirring is needed (based on any of, or a combination of the volume of fluid, the viscosity of the fluid, or the thickness of the suspension to be stirred). Additionally, the stir bar (103) is in the exemplary embodiment coated with a material to maintain the integrity of the stir bar, make it easy to clean, and not contaminate the fluid. The coating of the stir bar (103) may be a substance including but not limited to glass, nickel, ceramic, porcelain, Teflon®, or generic PTFE. Additionally, the stir bar (103) may be a variety of shapes (each in a variety of dimensions) as described, in FIG. 5 (500) with a basic explanatory representation in the form of block diagrams of embodiments of stir bars. These exemplary embodiments may include but are not limited to a simple bar (501) (as is used the given embodiment), and oval shape (502), or a dumbbell shape (503). A two pole magnet stir bar (103) may also have a pivot ring (504) protruding around the mid-point of the bar to provide a point of rotation allowing for less friction against the bottom of the vessel (101), providing greater efficiency. Furthermore, the stir bar (103) may be a multi-pole magnet (e.g., in a X shape (505), or in a disc shape (506), amongst others, and may have a pivot point protruding from the center to provide a point of rotation allowing for less friction against the bottom of the vessel (101)).

Additionally, in the example of FIG. 1 (100) the vessel (101) sits atop the SPCS base (104). This base (104) contains the rotating magnet (105) (please note this may be a magnet of the various stir bar compositions, it may be an electromagnet, or a combination of these, additionally it may be physically stationary but induces a rotating magnetic field) that provides the impetus to the stir bar (103), the heating element (106), the receptacle (point of connection) for the wired version of the thermal probe (107), the control panel (108), and the electric power source attachment (109). Additionally, the base (104) may also contain elements including, but not limited to; a general purpose computer system, a wired or wireless communication system, a speaker, a microphone, etc. The top of the base (104) is generally of a material that is relatively hard, durable, easy to clean, corrosion resistant, and importantly does not materially interfere with the magnetic coupling between the stir bar (103) and the rotating magnet (105). Additionally, the top of the base in the example embodiment is flat but may have a concave shape such that the vessel (101) may be placed inside the concave space of the top such that a portion (or all) of the sides of the vessel (101) are enveloped by the top. The rotating magnet (105) is contained in the base (104) and is attached to a variable speed electric motor. The rotating magnet (105) may be a permanent magnet (made of neodymium iron boron (NdFeB), samarium cobalt (SmCo), alnico, ceramic/ferrite, or a combination of these), an impermanent electro-magnet, or combination of these. Furthermore, the rotating magnet (105) in the exemplary case may be a bar shaped two pole magnets but may also be a multi-pole magnet (e.g., in a X shape, or in a disc shape). The magnetic attraction between the stir bar (103) and the rotating magnet (105) must be of sufficient strength such that there is a magnetic coupling between the two, and the rotation of the rotating magnet (105) rotates the stir bar (103). The rotation of the two should be coordinated, in parallel, with close to the same axis of rotation, and has close to an equal rate of rotation. It may be the case that at high rates of rotation or if something interrupts the stir bar (103) the stir bar (103) may become uncoupled from the rotating magnet (105) causing the stirring to stop. In an alternative embodiment, the drag on the motor that drives the rotating magnet (105) by the coupling with the stir bar (103) may be monitored and if that drag materially changes an alert may be provided to the user to warn of a possible performance issue. Furthermore, periodically, the rate of rotation of the rotating magnet (105) may be reduced (including fully stopping the rotation) to ensure strong magnetic coupling between the rotating magnet (105) and the stir bar (103). Additionally, limitations may be set on the maximum rotational speed and/or the rate of change to the rotational speed of the rotating magnet (105) to further ensure a strong magnetic coupling. Also, in an alternative embodiment a variety of standard randomization approaches may be applied to the rotating magnet (105) rotational speed, including but not limited to any one of the following techniques (or a combination of multiple techniques, with or without element repetition, and with or without sequencing); simple, replacement, block, permuted block, biased coin, minimization, stratified, covariate adaptive, and response adaptive to optimize stirring and achieve thermal homogeneity of the fluid in the vessel (101).

Furthermore, in the example of FIG. 1 (100) the heating element (106) is contained within the base (104). The heating element (106) is a standard electrical variable heating element that enables the heating of the vessel (101). In an alternative embodiment the heating element (106) may be a cooling element allowing for the preparation of cool or cold items. The thermal probe (107) for example but not limitation is connected to the base (104) (wired or wirelessly) and the temperature measurement portion of the probe is submerged in the fluid, reporting on the temperature of the fluid (or may be placed wired or wirelessly in or on the item being cooked). The thermal probe (107) creates a feedback loop with the variable heating element (106) control system causing the heating element (106) to increase or decrease the amount of heat emitted.

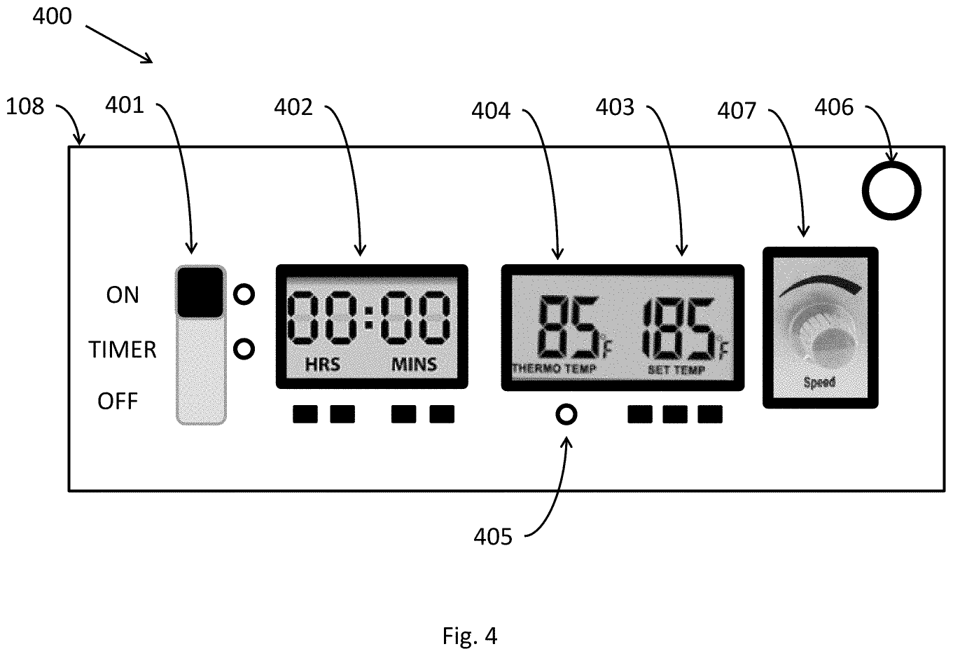

Also, in the example of FIG. 1 (100) the base (104) includes the control panel (108). The control panel (108) is further detailed in FIG. 4 (400) a basic explanatory representation in the form of a block diagram of the control panel (108). In this exemplary embodiment the control panel (108) provides a user interface including for example purposes the following elements; a three position power switch (On/Off/Timer) with one or more light emitting diode (LED) On/Off/Timer indicator light (401), a count-down timer input with digital LED or liquid crystal display (LCD) four position readout (HH:MM) and four associated cycling push buttons (with the ranges of 0-3, 0-9, 0-9, 0-9)—with a maximum of 39 hours and 99 minutes (402), a temperature control input with digital LED or LCD three position readout and three associated cycling push buttons (with ranges of 0-2, 0-9, 0-9)—with a maximum of temperature of 299 degrees Fahrenheit (403), an associated LED/LCD readout to show current vessel fluid temperature (404), a LED light to indicate heating (405), a port/receptacle (for the wired version) to connect the thermal probe (406), a rotating variable potentiometer control to set the rate of rotation for the rotating magnet (407) (105). It should be noted that these setting ranges, and the specificity of these ranges are related to the present example but could vary in alternate embodiments. Additionally, each or any of the settings and related reporting may be discrete or continuous, digital or analog. Alternatively, all of these controls and related reporting may be conducted completely, in part, and/or in parallel via an on-base or remote from the base touch screen (or non-touchscreen control—e.g., a smart phone with an associated application). There may be additional indicators on/from the base (104), visual, auditory, or both, related to items including but not limited to: temperature is reached, full cooking time reached, the stir bar (103) is not working correctly, SPCS is being controlled by a remote app, etc. The base (104) is also attached via a power cord (109) to an electrical source.

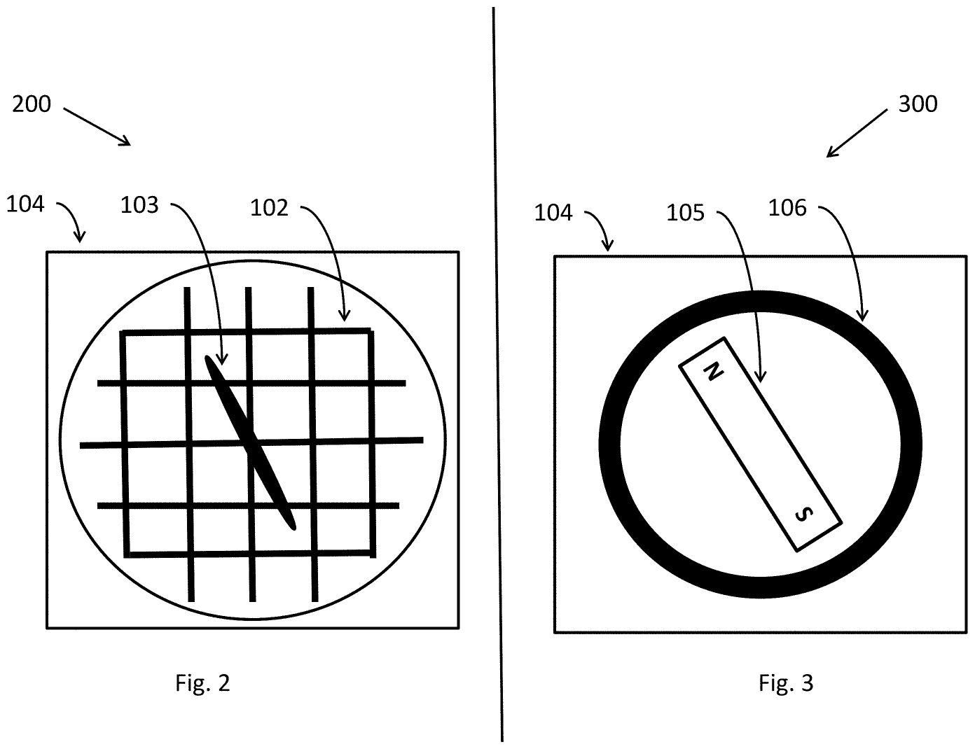

For example, but not limitation, FIG. 2 (200) is a basic explanatory representation in the form of block diagram top view of the SPCS. In this exemplary embodiment the base (104) has a vessel (101) sitting on top of it, and inside the vessel (101) is a stir bar (103) and a rack above (102) and/or around the stir bar (103). In this example the rack (102) is effectively a screen with relatively large openings that sits above and/or around the stir bar (103) and does not materially negatively impact the stirring of the fluid. In alternative embodiments including but not limited to; the rack may sit on legs that rest on the bottom of the vessel (101), fit in the vessel (101) against the sides such that it does not go lower than a given height, is hung from the side or top edge or lid of the vessel (101), the rack (102) may comprise a basket that fits within the vessel (101) that may be removed. The rack may also have vertical elements that can act as dividers or supports for the bags of food to be cooked—ensuring space for the fluid to circulate, enabling thermal homogeneity. The size of the spaces in the rack may be of consistent throughout or different sizes and large or small, as long as the fluid thermal homogeneity is maintained in the case of Sous-vide cooking. It should also be noted that in some cases no rack is needed in the case of cooking items that benefit from stirring and homogeneous heating including but not limited to drinks (e.g., coffee, tea, cocoa, mixed drinks, etc.), sauces, broths, soups, mashes, puddings, suspensions, slurries, slushies, or anything that can successfully stir with a magnetic stirrer. Furthermore, heterogeneous foods with a significant fluid component like thick soups or stews may also be cooked with a rack (102) such that the fluid circulates but the larger items do not interfere with the magnetic stir bar's (103) activity.

For example, but not limitation, FIG. 3 (300) is a basic explanatory representation in the form of block diagram cut-away view of the SPCS. In this exemplary embodiment the top of the base (104) is removed to expose the rotating magnet (105) and the heating element (106). In this example, the rotating magnet (105) is a two pole (N/S) magnet that rotates in a planar way in a single direction around a central axis (please note the direction may be clockwise or counter clockwise but during operation it rotates in a single direction). It is generally most beneficial to have the rotating magnet (105) close to the top of the base (104) to provide close proximity to the stir bar (103), maximizing the strength of magnetic coupling (in the case of a non-flat, concave top the rotating magnet (105) may be on the top, the sides or both in a single or multiple pieces to cause the stir bar (103) to rotate as intended. The heating element (106) is optimally placed close to or against the top of the base (104) to provide the most optimum thermal transfer rate. In this example case the heating element (106) is circular but in alternative embodiments the heating element may be in a variety of shapes that may be continuous or sectional. Additionally, the heating methodology may be, by means of example but not limitation; resistive, conduction, induction, hot water (fluid), hot air (gas), light, infrared, etc. Furthermore, the heating element may be part of the top of the base (104) or separate from it (in the case of a non-flat, concave top the heating element (106) may be on the top, the sides or both). In alternative embodiments the heating element (106) may actually be a cooling element.

The SPCS may have a general-purpose computer system resident in, or remote from, the base (104) (or both) to help support more complex and/or connected activities. In an alternative embodiment, the SPCS may also be coupled wirelessly with a remote device. By example, not limitation, this remote device may be a smart phone that is running a SPCS management application. Also, by means of this example, but not limitation this application is able to set the controls that are accessible through the control panel (108) and also information may be relayed to the application on the remote device including, but not limited to, time that it has been cooking, current time left on the timer (402), target temperature (403), current temperature (403), stir bar (103) rotation rate target (407), coupling of the stir bar (103) to the rotating magnet (104) status, current sir bar (103) rotation rate. Also, in alternative embodiments where the vessel (101) has a sealed lid, internal pressure. Furthermore, alerts and or alarms may be pushed to the remote device around cooking status (e.g., cooking completion, target temperature reached, stir bar (103) coupling with the rotating magnet (104) has been lost, etc.). Furthermore, the SPCS may be commutatively connected to connected home devices such as Amazon Alexa® or Google Home®, or monitoring devices like Ring® Cams, for both control and reporting of the SPCS performance. Additionally, there may pre-established settings for specific cooking settings (user defined or third party defined) that may be stored local to the SPCS or remote from it. Furthermore, cooking setting from places like cook books, magazines, and web sites may be imported to set the control parameters for cooking with the SPCS. Additionally, the base (104) may be of sufficient size to house multiple cooking areas each with individual rotating magnets (105), heating elements (106), thermal probes (107), and controls (108) such that multiple vessels (101), each with their own racks (102) and stir bars (103) can simultaneously cook multiples of the same things or different things, all simultaneously (or at different times). It may be the case in alternative embodiments that the entire base (108) is subsumed in a traditional cook top with a single or multiple SPCS cooking areas (a SPCS may replace a traditional stove style cook top).

The exemplary system described herein is a system for cooking food by means submersion in a homogenously heated fluid bath comprising: at least one vessel (101) containing at least one item to be cooked, a fluid capable of being heated by means of at least one heating element (106), the fluid being capable of being mixed by means of at least one magnetic stir rod (103) such that the fluid is thermally homogenous; at least one base unit (104) configured to have at least one vessel (101) placed upon it, comprising at least one means of heating the fluid, at least one means of magnetically coupling with at least one magnetic stir rod (103) contained in the at least one vessel (101) and causing the at least one stir rod (103) to rotate in a coordinated manner, agitating the fluid to cause the fluid to be thermally homogenous; at least one thermal probe (107) to measure and report on the temperature of the fluid (404); at least one thermal control to set the desired temperature of the fluid (403); at least one timer (402) to control the duration of the heating of the fluid, and at least one rotation speed control (407) to set the rate of the rotation of the at least one magnetic stir rod (103). Additionally, the at least one vessel (101) may be further configured to include at least one rack (102) that may be placed within the at least one vessel (101) to ensure that the motion of the at least one magnetic stir rod (103) is not interfered with by the at least one item to be cooked (or any other item in the vessel). Also, the at least one heating element (106) may be further configured to cool the fluid in the vessel and the top surface of the at least one base unit (104) on which the at least one vessel (101) is placed may be concave such that the at least one vessel (101) may be surrounded by the at least one base unit (104) surface on the bottom and sides. Furthermore, the at least one thermal probe (107) may be used to measure and report on the temperature of the at least one item being cooked. Also, it should be understood that the at least one item to be cooked may be the fluid itself (e.g., soups, slushies, drinks, etc.) and the at least one item to be cooked may be a non-food item.

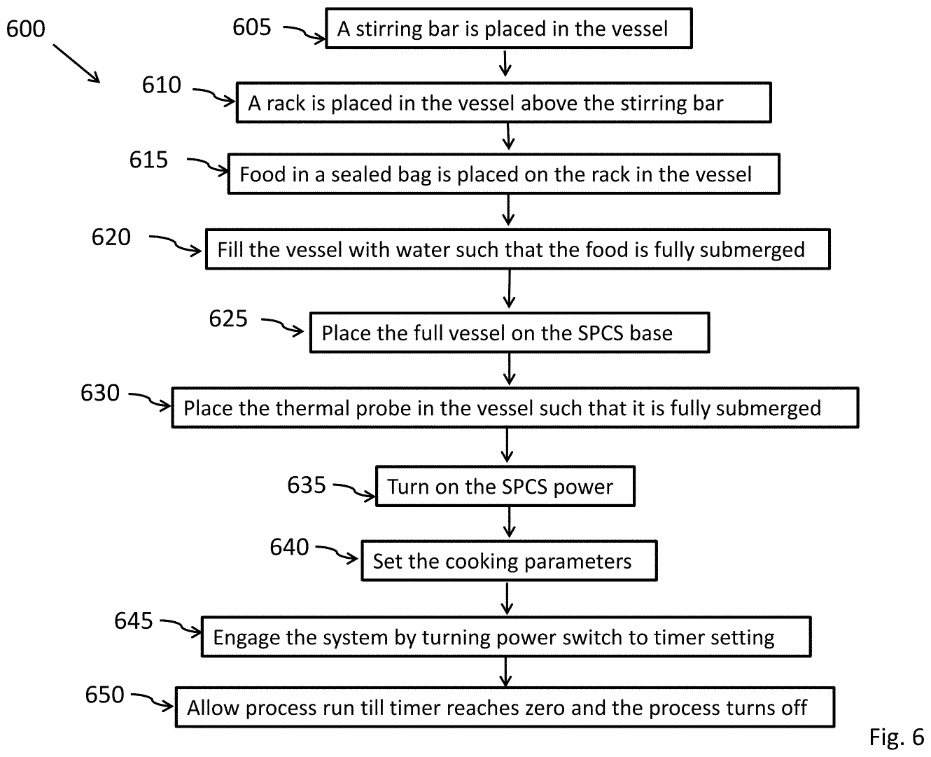

FIG. 6 (600) illustrates a flowchart for a method according to an exemplary first embodiment. The Sous-vide method generically follows the following steps; a stir bar (103) is placed into a vessel (101) (605), a rack (102) is placed into the vessel (101) such that it and the items being cooked do not interfere with the activity of the stir bar (103) (610), the food in a sealed plastic bag to be cooked is placed in the vessel (101), on the rack (102) (615), water is added to the vessel (101) such that the bagged food is submerged in the water (620), the full vessel (101) is placed on the base (104) (625), the thermal probe (107) is placed such that the temperature measuring part of the thermal probe is submerged in the fluid (or placed in or on the item being cooked) (630) and the thermal probe connector is commutatively coupled to the base (104), the SPCS is turned on (401) (635), the cooking parameters are set on the control panel (401) (640), the SPCS timer (402) is engaged (by turning the power switch to timer) (645), the SPCS runs for the duration of the cooking session (please note if an error occurs (e.g., heating failure, de-coupling of the stir bar(103), etc.) an alarm may sound, a light may flash, an alert may be sent, or a combination of these) until SPCS turns off when the timer reaches zero time left (650). Following this the perfectly cooked food may be served.

A method for cooking by means of the continued submersion of at least one food item in a homogenously heated fluid bath for a period of time, by means of: placing at least one magnetic stirring rod (103) into at least one cooking vessel (101); placing at least one item in at least one container that is to be cooked in the at least one vessel (101); adding fluid to the at least one vessel (101) such that the at least one item in the at least one container is submerged in the fluid; placing the at least one vessel on the at least one base unit (104); placing the at least one thermal probe (107) such that the temperature measuring part of the at least one thermal probe (107) is submerged in the fluid, and the at least one thermal probe connector is commutatively coupled (406) to the at least one base unit (104); providing electrical power (109) to the at least one base unit (104); setting the at least one temperature, at least one cooking time, and at least one rate of stir bar rotation parameters on the at least one base unit (104) control panel (108); engaging the cooking process in accordance with the at least one set of parameters; the process runs for the duration of the cooking session. Additionally, the at least one vessel (101) may be further configured to receive at least one rack (102) that may be placed within the at least one vessel (101) to ensure that the motion of the at least one magnetic stir rod (103) is not interfered with by the at least one item to be cooked (or interfered with by any other item in the at least one vessel). Also, the at least one temperature parameter (403) of the heating element (106) may be configured to cool the fluid in the at least one vessel (101) and the at least one vessel (101) is placed on the top surface of the at least one base unit (104) which may be concave such that the at least one vessel (101) may be surrounded by the at least one base unit (104) surface on the bottom and sides. Furthermore, the at least one thermal probe (107) may be placed on the at least one item to be cooked itself, measuring and reporting on the temperature of the at least one item being cooked itself. Also, the fluid itself may be the at least one item to be cooked and non-food items may be the at least one item cooked.

Exemplary systems include systems; that may be commutatively coupled with the SPCS, sending data to different display devices as in U.S. Pat. Nos. 9,571,875, 9,924,215, and 10,631,033 the contents of which are hereby incorporated by reference.

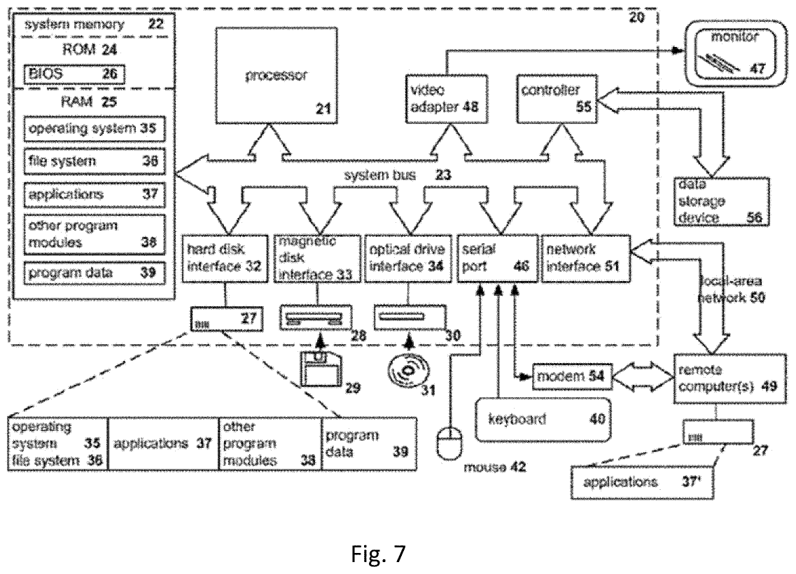

FIG. 7 illustrates an example of a general-purpose computer system (which may be a personal computer, a server, or a plurality of personal computers and servers) on which the disclosed system and method can be implemented according to an example aspect. It should be appreciated that the detailed general-purpose computer system can correspond to the CCMS (300) described above with respect to FIG. 3 (300) to implement the algorithms described above. This general-purpose computer system may exist in a single physical location, with a broadly distributed structure, virtually as a subset of larger computing systems (e.g. in the computing “cloud”), or a combination of any of these.

As shown, the computer system 20 includes a central processing unit 21, a system memory 22 and a system bus 23 connecting the various system components, including the memory associated with the central processing unit 21. The central processing unit 21 can be provided to execute software code (or modules) for the one or more set of rules discussed above which can be stored and updated on the system memory 22. Additionally, the central processing unit 21 may be capable of executing traditional computing logic, quantum computing, or a combination of both. Furthermore, the system bus 23 is realized like any bus structure known from the prior art, including in turn a bus memory or bus memory controller, a peripheral bus and a local bus, which is able to interact with any other bus architecture. The system memory includes read only memory (ROM) 24 and random-access memory (RAM) 25. The basic input/output system (BIOS) 26 includes the basic procedures ensuring the transfer of information between parts of the personal computer 20, such as those at the time of loading the operating system with the use of the ROM 24.

As noted above, the rules described above can be implemented as modules according to an exemplary aspect. As used herein, the term “module” refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer. Accordingly, each module can be realized in a variety of suitable configurations, and should not be limited to any example implementation exemplified herein.

The personal computer 20, in turn, includes a hard disk 27 for reading and writing of data, a magnetic disk drive 28 for reading and writing on removable magnetic disks 29 and an optical drive 30 for reading and writing on removable optical disks 31, such as CD-ROM, DVD-ROM and other optical information media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the personal computer 20. Moreover, it is noted that any of the storage mechanisms (including data storage device 56, which may be amongst other things, physical hardware, CDN(s), or the “cloud”) can serve as the storage of the media Content, including the Available Content Library (111) described above, according to an exemplary aspect as would be appreciated to one skilled in the art.

The present disclosure provides the implementation of a system that uses a hard disk 27, a removable magnetic disk 29 and/or a removable optical disk 31, but it should be understood that it is possible to employ other types of computer information media 56 which are able to store data in a form readable by a computer (solid state drives, flash memory cards, digital disks, random-access memory (RAM) and so on), which are connected to the system bus 23 via the controller 55.

The computer 20 has a file system 36, where the recorded operating system 35 is kept, and also additional program applications 37, other program modules 38 and program data 39. The user is able to enter commands and information into the personal computer 20 by using input devices (keyboard 40, mouse 42). Other input devices (not shown) can be used: microphone, joystick, game controller, scanner, other computer systems, and so on. Such input devices usually plug into the computer system 20 through a serial port 46, which in turn is connected to the system bus, but they can be connected in other ways, for example, with the aid of a parallel port, a game port, a universal serial bus (USB), a wired network connection, or wireless data transfer protocol. A monitor 47 or other type of display device is also connected to the system bus 23 across an interface, such as a video adapter 48. In addition to the monitor 47, the personal computer can be equipped with other peripheral output devices (not shown), such as loudspeakers, a printer, and so on.

The personal computer 20 is able to operate within a network environment, using a network connection to one or more remote computers 49, which can correspond to the remote viewing devices, i.e., the IP connected device (e.g., a smartphone, tablet, personal computer, laptop, media display device, or the like). Other devices can also be present in the computer network, such as routers, network stations, peer devices or other network nodes.

Network connections 50 can form a local-area computer network (LAN), such as a wired and/or wireless network, and a wide-area computer network (WAN). Such networks are used in corporate computer networks and internal company networks, and they generally have access to the Internet. In LAN or WAN networks, the personal computer 20 is connected to the network 50 across a network adapter or network interface 51. When networks are used, the personal computer 20 can employ a modem 54 or other modules for providing communications with a wide-area computer network such as the Internet or the cloud. The modem 54, which is an internal or external device, is connected to the system bus 23 by a serial port 46. It should be noted that the network connections are only examples and need not depict the exact configuration of the network, i.e., in reality there are other ways of establishing a connection of one computer to another by technical communication modules, such as Bluetooth.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A system for cooking food by means submersion in a homogenously heated fluid bath comprising:
at least one vessel containing at least one item to be cooked, a fluid capable of being heated by means of at least one heating element, the fluid being capable of being mixed by means of at least one magnetic stir rod such that the fluid is thermally homogenous;
at least one base unit configured to have at least one vessel placed upon it, comprising at least one means of heating the fluid, at least one means of magnetically coupling with at least one magnetic stir rod contained in the at least one vessel and causing the at least one stir rod to rotate in a coordinated manner, agitating the fluid to cause the fluid to be thermally homogenous;
at least one thermal probe to measure and report on the temperature of the fluid;
at least one thermal control to set the desired temperature of the fluid;
at least one timer to control the duration of the heating of the fluid, and at least one rotation speed control to set the rate of the rotation of the at least one magnetic stir rod.

2. The system according to claim 1, wherein the at least one vessel is further configured to include at least one rack that may be placed within the at least one vessel to ensure that the motion of the at least one magnetic stir rod is not interfered with by the at least one item to be cooked.

3. The system according to claim 1, wherein the at least one heating element is further configured to cool the fluid in the vessel.

4. The system according to claim 1, wherein the top surface of the at least one base unit on which the at least one vessel is placed is concave such that the at least one vessel is surrounded by the at least one base unit surface on the bottom and sides.

5. The system according to claim 1, wherein the at least one thermal probe is used to measure and report on the temperature of the at least one item being cooked.

6. The system according to claim 1, wherein the at least one item to be cooked is the fluid itself.

7. The system according to claim 1, wherein the at least one item to be cooked is a non-food item.

8. A method for cooking by means of the continued submersion of at least one food item in a homogenously heated fluid bath for a period of time, by means of:
placing at least one magnetic stirring rod into at least one cooking vessel;
placing at least one item in at least one container that is to be cooked in the at least one vessel;
adding fluid to the at least one vessel such that the at least one item in the at least one container is submerged in the fluid;
placing the at least one vessel on the at least one base unit;
placing the at least one thermal probe such that the temperature measuring part of the at least one thermal probe is submerged in the fluid, and the at least one thermal probe connector is commutatively coupled to the at least one base unit;
providing electrical power to the at least one base unit;
setting the at least one temperature, at least one cooking time, and at least one rate of stir bar rotation parameters on the at least one base unit control panel;
engaging the cooking process in accordance with the at least one set of parameters;
the process runs for the duration of the cooking session.

9. The method according to claim 8, wherein the at least one vessel is further configured to receive at least one rack that may be placed within the at least one vessel to ensure that the motion of the at least one magnetic stir rod is not interfered with by the at least one item to be cooked.

10. The method according to claim 8, wherein the at least one temperature parameter of the heating element is configured to cool the fluid in the at least one vessel.

11. The method according to claim 8, wherein the at least one vessel is placed on the top surface of the at least one base unit which is concave such that the at least one vessel is surrounded by the at least one base unit surface on the bottom and sides.

12. The method according to claim 8, wherein the at least one thermal probe is placed on the at least one item to be cooked itself, measuring and reporting on the temperature of the at least one item being cooked itself.

13. The method according to claim 8, wherein the fluid itself is the at least one item to be cooked.

14. The method according to claim 8, wherein non-food items are the at least one item cooked.
